(19) United States
(12) Patent Application Publication
(10) Pub. No.: US 2024/0167823 A1
(43) Pub. Date: May 23, 2024

(54) AUTONOMOUS TRAVELING VEHICLE, AND OWN-POSITION ESTIMATING METHOD FOR AUTONOMOUS TRAVELING VEHICLE

(71) Applicant: KABUSHIKI KAISHA TOYOTA JIDOSHOKKI, Kariya-shi, Aichi-ken (JP)

(72) Inventor: Takashi UNO, Kariya-shi (JP)

(73) Assignee: KABUSHIKI KAISHA TOYOTA JIDOSHOKKI, Kariya-shi, Aichi-ken (JP)

(21) Appl. No.: 18/282,869

(22) PCT Filed: Mar. 23, 2022
(86) PCT No.: PCT/JP2022/013624

§ 371 Date: Sep. 19, 2023

(30) Foreign Application Priority Data
Mar. 24, 2021 (JP) 2021-050338

(51) Int. Cl. G01C 21/30; G06T 7/73; H04N 5/262

(52) U.S. Cl. CPC G01C 21/30; G06T 7/74; H04N 5/2628; G06T 2207/30256

(57) ABSTRACT

An autonomous vehicle includes a camera and circuitry. The circuitry is configured to estimate a self-location using an image data set obtained from the camera and a map data set that associates a positional information set with each of multiple map image data sets. The circuitry is configured to obtain a clipped image data set from the image data set, identify one of the map image data sets that corresponds to the clipped image data set by executing a matching process between the clipped image data set and the map image data sets, and estimate the self-location from the identified map image data set and the clipped image data set. Each positional information set is associated with a coordinate point representing an optical axis position of the camera in a coordinate system representing a pixel position of the corresponding map image data set.

### TECHNICAL FIELD

The present disclosure relates to an autonomous vehicle and a self-location estimating method in the autonomous vehicle.

### BACKGROUND ART

An autonomous vehicle disclosed in Patent Literature 1 includes a camera, a storage device, and a control unit. The camera is arranged to capture images of a road surface. The storage device stores a map data set. The map data set is a data set that associates a positional information set with each of multiple map image data sets. Each positional information set is associated with, for example, a center pixel of the corresponding map image data set. The control unit obtains image data sets from the camera. The control unit executes a matching process between the image data sets and the map image data sets. Through the matching process, the control unit identifies the map image data set that corresponds to each image data set. The control unit estimates the self-location based on the positional information set associated with the map image data set and the relative positional relationship between the map image data set and the image data set. The relative positional relationship between the map image data set and the image data set is indicated by the amount of deviation between one of the pixels forming the map image data set to which the positional information set is associated and a pixel of the image data set that corresponds to that one of the pixels forming the map image data set. If the positional information set is associated with the center pixel of the map image data, the amount of deviation between the center pixel of the image data and the center pixel of the map image data matched with the image data indicates the relative positional relationship between the map image data set and the image data set.

### CITATION LIST

### Patent Literature

Patent Literature 1: U.S. Pat. No. 8,725,413

### SUMMARY OF INVENTION

### Technical Problem

In order to reduce the processing time required to estimate the self-location, the control unit of the autonomous vehicle may estimate the self-location using only part of the image data set. In this case, the relative positional relationship between the map image data set and the image data set may change due to vertical movement of the camera. Such changes in the relative positional relationship can reduce accuracy of the self-location estimation.

### Solution to Problem

In a general aspect, an autonomous vehicle includes a camera that is arranged to face in a vertical direction so as to capture images of a road surface, a storage device that is configured to store a map data set that associates a positional information set with each of multiple map image data sets obtained by capturing images of the road surface in advance, an obtaining unit that is configured to obtain an image data set from the camera, and a self-location estimating unit that is configured to estimate a self-location using the map data set and the image data set. The self-location estimating unit is configured to obtain a clipped image data set by clipping a predetermined range from the image data set, identify one of the map image data sets that corresponds to the clipped image data set by executing a matching process between the clipped image data set and at least one of the map image data sets, and estimate the self-location from a relative positional relationship between the identified map image data set and the clipped image data set. Each positional information set is associated with a coordinate point representing an optical axis position of the camera in a coordinate system representing a pixel position of the corresponding map image data set.

In another general aspect, a self-location estimating method in an autonomous vehicle includes: capturing images of a road surface with a camera that is arranged in the autonomous vehicle so as to face in a vertical direction; storing, in a storage device, a map data set that associates a positional information set with each of multiple map image data sets obtained by capturing images of the road surface in advance; obtaining an image data set from the camera; obtaining a clipped image data set by clipping a predetermined range from the image data set; identifying one of the map image data sets that corresponds to the clipped image data set by executing a matching process between the clipped image data set and at least one of the map image data sets; and estimating the self-location from a relative positional relationship between the identified map image data set and the clipped image data set. Each positional information set is associated with a coordinate point representing an optical axis position of the camera in a coordinate system representing a pixel position of the corresponding map image data set.

### BRIEF DESCRIPTION OF DRAWINGS

FIG. 1 is a side view of an autonomous vehicle.

FIG. 2 is a block diagram showing an electrical configuration of the autonomous vehicle shown in FIG. 1.

FIG. 3 is a flowchart showing a map generating process executed by the controller shown in FIG. 2.

FIG. 4 is a diagram showing an example of an image data set generated by the camera shown in FIG. 1.

FIG. 5 is a diagram showing an example of a map data set generated by the controller shown in FIG. 2.

FIG. 6 is a flowchart showing a self-location estimating process executed by the controller shown in FIG. 2.

FIG. 7 is a diagram showing an example of a clipped image data set obtained by the controller shown in FIG. 2.

FIG. 8 is an explanatory diagram of a relative positional relationship between a map image data set and a clipped image data set.

FIG. 9 is a diagram showing a map data set generated by a controller of a comparative example.

FIG. 10 is a diagram showing a clipped image data set obtained by the controller of the comparative example.

FIG. 11 is an explanatory diagram of operation of the embodiment.

### DESCRIPTION OF EMBODIMENTS

An autonomous vehicle according to an embodiment will now be described. In the following description, directional terms such as front, rear, left, and right are defined with reference to the autonomous vehicle. The front-rear direction coincides with the traveling direction of the autonomous vehicle. The left-right direction coincides with the vehicle width direction of the autonomous vehicle.

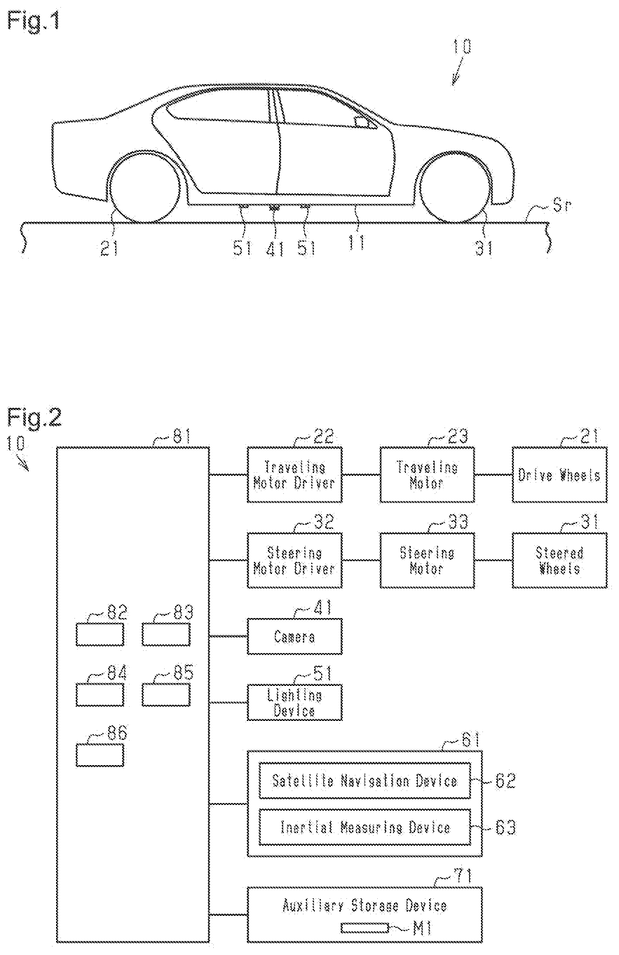

As illustrated in FIGS. 1 and 2, the autonomous vehicle 10 includes a vehicle body 11, drive wheels 21, steered wheels 31, a traveling motor driver 22, a traveling motor 23, a steering motor driver 32, a steering motor 33, a camera 41, a lighting device 51, a positioning device 61, a controller 81, and an auxiliary storage device 71. The autonomous vehicle 10 may be a passenger car or may be an industrial vehicle. Industrial vehicles include forklifts, towing tractors, and automated guided vehicles.

The traveling motor 23 is a motor for rotating the drive wheels 21. The traveling motor driver 22 drives the traveling motor 23 in response to a command from the controller 81. The autonomous vehicle 10 travels when the drive wheels 21 are rotated by driving of the traveling motor 23. The steering motor 33 is a motor for steering the steered wheels 31. The steering motor driver 32 drives the steering motor 33 in response to a command from the controller 81. When the steered wheel 31 are steered by driving the steering motor 33, the autonomous vehicle 10 turns.

The camera 41 includes a digital camera. The camera 41 includes an image sensor. The image sensor may be, for example, a charge coupled device (CCD) image sensor or a complementary metal oxide semiconductor (CMOS) image sensor. The camera 41 may be, for example, an RGB camera, an infrared camera, a grayscale camera, or a visible light camera.

The camera 41 captures images at a specified frame rate to generate image data sets. The image data sets are digital data of images captured by the camera 41.

The camera 41 is disposed to capture images of a road surface Sr. The camera 41 substantially generates image data sets that represent images of the road surface Sr. The camera 41 is provided on the bottom of the vehicle body 11 in a state of facing in the vertical direction. Specifically, the camera 41 is provided such that the optical axis of the camera 41 coincides with the vertical direction. The state in which the camera 41 faces in the vertical direction allows errors due to the mounting accuracy of the camera 41, and the camera 41 may be mounted in a state in which the camera 41 faces in a direction slightly deviated from the vertical direction.

The lighting device 51 is disposed so as to illuminate the road surface Sr. Specifically, the lighting device 51 illuminates a range of the road surface Sr that is captured by the camera 41. In the present embodiment, the lighting device 51 is provided on the bottom of the vehicle body 11 in a state of facing downward. As the lighting device 51, for example, a light-emitting diode can be used.

The positioning device 61 includes a satellite navigation device 62 and an inertial measuring device 63. The satellite navigation device 62 measures a position using satellite signals transmitted from satellites of a global navigation satellite system (GNSS). The inertial measuring device 63 includes a gyroscope sensor and an acceleration sensor.

The controller 81 includes a processor 82 and a storage unit 83. The processor 82 may be, for example, a central processing unit (CPU), a graphics processing unit (GPU), or a digital signal processor (DSP). The storage unit 83 includes a random-access memory (RAM) and a read-only memory (ROM). The storage unit 83 stores program codes or commands configured to cause the processor 82 to execute processes. The storage unit 83, which is a computer-readable medium, includes any type of medium that is accessible by a general-purpose computer or a dedicated computer. The controller 81 may include a hardware circuit such as an application specific integrated circuit (ASIC) and a field programmable gate array (FPGA). The controller 81, which is processing circuitry, may include one or more processors that operate according to a computer program, one or more hardware circuits such as an ASIC and an FPGA, or a combination thereof.

The controller 81 includes a map generating unit 84, an obtaining unit 85, and a self-location estimating unit 86. The map generating unit 84, the obtaining unit 85, and the self-location estimating unit 86 are functional elements that function when the controller 81 executes predetermined programs.

The auxiliary storage device 71 stores information that can be read by the controller 81. The auxiliary storage device 71 may be a hard disk drive, a solid state drive, or a flash memory, for example.

The auxiliary storage device 71 stores a map data set M1. The map data set M1 associates a positional information set with each of map image data sets obtained by capturing images of the road surface Sr in advance. The positional information set includes coordinate information and orientation information. The coordinate information is a coordinate point in a map coordinate system, which is a coordinate system representing absolute positions. The map coordinate system may be a Cartesian coordinate system or a geographical coordinate system. The orientation information is information representing an inclination with respect to a coordinate axis of the map coordinate system. The auxiliary storage device 71 is a storage device that stores the map data set M1.

The map data set M1 is generated in advance. The map data set M1 can be obtained, for example, by causing the autonomous vehicle 10 to travel in advance in locations where the autonomous vehicle 10 is expected to travel. The map generating process will now be described. The map generating process is a process executed by the controller 81 when generating the map data set M1.

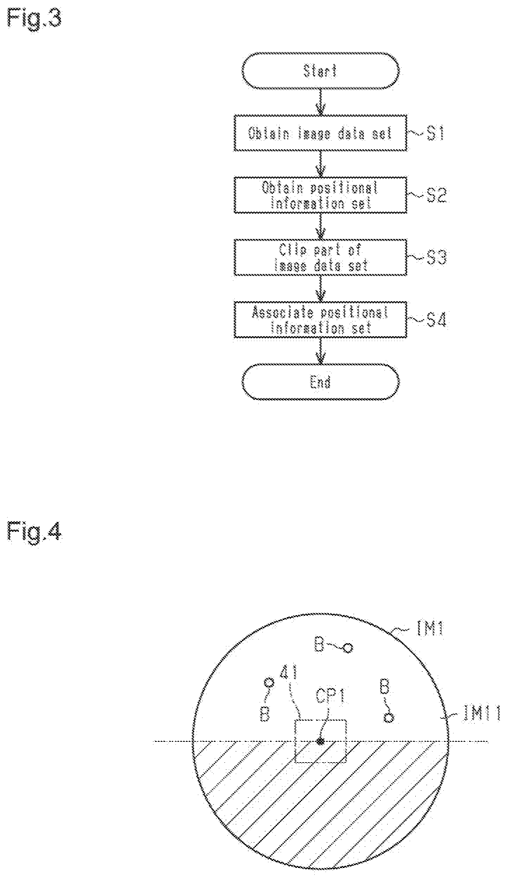

As shown in FIG. 3, the controller 81 obtains image data sets from the camera 41 in step S1. As an example, a case will be described in which an image data set IM1 shown in FIG. 4 is obtained. As shown in FIG. 4, the image data set IM1 of the present embodiment is circular image data. Features B of the road surface Sr are shown in the image data set IM1. Features of the road surface Sr include, for example, unevenness of the road surface Sr. In the present embodiment, the features B of the road surface Sr are illustrated schematically.

As shown in FIG. 3, in the subsequent step S2, the controller 81 obtains a positional information set. The positional information set can be obtained using the positioning device 61. The positional information set can be calculated from, for example, the longitude and latitude obtained using the satellite navigation device 62 and a movement amount calculated using the inertial measuring device 63.

Next, in step S3, the controller 81 clips part of the image data set IM1. In the present embodiment, half of the image data set IM1 is clipped. In the example shown in FIG. 4, a range excluding the hatched section is clipped from the image data set IM1. The controller 81 uses the clipped image data set as a map image data set IM11. The map image data set IM11 is substantially semicircular image data. For example, the controller 81 can clip a range extending in any direction such as a front half, a rear half, a right half, or a left half of the image data set IM1. In the present embodiment, the front half of the image data set IM1 is clipped. The size of the map image data set IM11, which is clipped from the image data set IM1, and the position of the map image data set IM11, which is clipped from the image data set IM1, can be set freely.

Next, in step S4, the controller 81 associates the positional information set obtained in step S2 with the map image data set IM11. Specifically, the controller 81 associates, with the map image data set IM11, the positional information set obtained at the same time as the time when the image data set IM1 is obtained in step S1. As shown in FIG. 4, the controller 81 associates the positional information set with a coordinate point CP1 that represents the optical axis position of the camera 41 in the coordinate system representing positions of respective pixels constituting the map image data set IM11. The coordinate system representing the pixel positions of the map image data set IM11 is an image coordinate system. The image coordinate system is a two-axis Cartesian coordinate system representing pixel positions in the image data set IM1. A pixel position in the image data set IM1 can be expressed by, for example, a coordinate representing the horizontal position of the pixel and a coordinate representing the vertical position of the pixel. Since the map image data set IM11 is obtained by clipping part of the image data set IM1, a pixel position in the map image data set IM11 can be expressed by an image coordinate system. The coordinate point CP1, which represents the optical axis position of the camera 41 in the image coordinate system, coincides with the center point of the image data set IM1 before the map image data set IM11 is clipped. If the map image data set IM11 has a semicircular shape, the point located at the midpoint on the chord is the coordinate point CP1, which represents the optical axis position of the camera 41.

The controller 81 associates pixel scales with the map image data set IM11. A pixel scale refers to the actual size of one pixel. The controller 81 may associate, with the map image data set IM11, the point in time at which the image is captured or an image number assigned to each map image data set IM11.

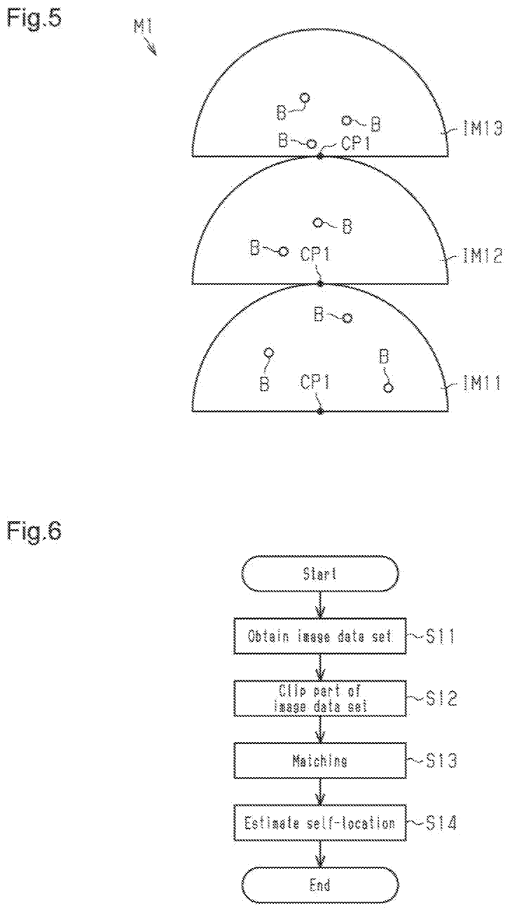

The controller 81 repeatedly executes the processes from step S1 to step S4 at a specified interval to generate the map data set M1. As shown in FIG. 5, the map data set M1 can be regarded as a data in which map image data sets IM11 to IM13 are arranged according to the positional information sets in the map coordinate system. As an example, a case will be described in which, as shown in FIG. 5, a map data set M1 is generated by three map image data sets IM11 to IM13. The controller 81 executing the map generating process substantially includes the map generating unit 84.

The controller 81 controls the traveling motor driver 22 and the steering motor driver 32 while estimating the self-location using the above-described map data set M1. The controller 81 thus moves the autonomous vehicle 10 to a target location. The target location may be set by the user of the autonomous vehicle 10 or may be set by a host controller that controls the autonomous vehicle 10.

The self-location estimating process executed by the controller 81 will now be described. The self-location estimating process is a routine that is repeatedly executed at a specified control cycle while the autonomous vehicle 10 is activated.

As shown in FIG. 6, in step S11, the controller 81 obtains an image data set from the camera 41. The controller 81 executing the process of step S11 substantially includes the obtaining unit 85.

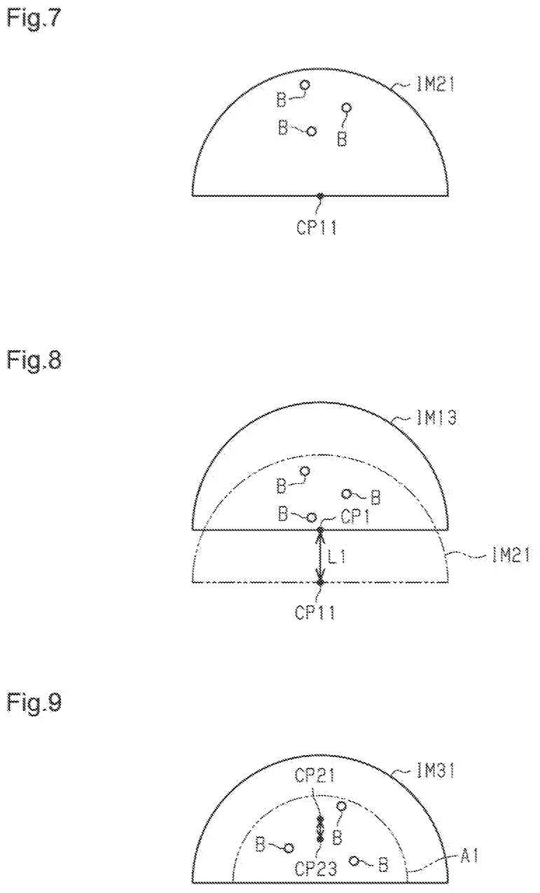

Next, in step S12, the controller 81 clips part of the image data set. At this time, the controller 81 clips part of the image data set such that the range clipped from the image data set is equal to the range from which the map image data sets IM11 to IM13 have been clipped. That is, the controller 81 clips part of the image data set that has the same part having the same size as the map image data sets IM11 to IM13. In the present embodiment, the front half of the image data set IM1 is clipped and is used as the map image data sets IM11 to IM13. Therefore, the controller 81 clips the front half of the image data set. Hereinafter, the image data set clipped from the image data set is referred to as clipped image data set. As an example, a case will be discussed in which the controller 81 obtains a clipped image data set IM21 shown in FIG. 7 by clipping the image data set. The pixel position of the clipped image data set IM21 can be expressed by a coordinate point in the image coordinate system. The pixel positions of the map image data sets IM11 to IM13 and the pixel position of the clipped image data set IM21 are substantially expressed by the same coordinate system. For example, the coordinate point CP1, which represents the midpoint on the chord of each of the map image data sets IM11 to IM13 and a coordinate point CP11 representing the midpoint on the chord of the clipped image data set IM21 can be expressed by the same coordinate point.

As shown in FIG. 6, next, in step S13, the controller 81 executes a matching process between the clipped image data set IM21 and at least one of the map image data sets IM11 to IM13. The controller 81 extracts one or more feature points from the clipped image data set IM21. The controller 81 describes the feature value of each extracted feature point. Examples of the feature value include a feature vector and a luminance value. Further, the controller 81 extracts one or more feature points from each of the map image data sets IM11 to IM13, and describes the feature value of each extracted feature point.

The controller 81 executes a matching process between the feature points and the feature value obtained from the clipped image data set IM21, and the feature points and the feature value obtained from the map image data sets IM11 to IM13, and searches for pairs of feature points having similar feature values. Based on the pairs of feature points, the controller 81 identifies the map image data set that corresponds to the clipped image data set IM21 among the map image data sets IM11 to IM13. For example, the controller 81 identifies the map image data set in which the pairs of feature points are concentrated as the map image data set corresponding to the clipped image data set IM21. The above-described matching process can be executed using a feature value descriptor. Examples of the feature value descriptor include the oriented FAST and rotated BRIEF (ORB), the scale-invariant feature transform (SIFT), and the speeded up robust features (SURF).

As an example, a case will be discussed in which the map image data set IM13 is identified as the map image data set corresponding to the clipped image data set IM21. As can be understood from FIGS. 5 and 7, the features B included in the clipped image data set IM21 and the features B included in the map image data set IM13 agree with each other. By executing a matching process in this way, it is possible to identify the map image data set IM13 in which the pattern of the features B matches or is similar to that of the clipped image data set IM21.

As shown in FIG. 6, next, in step S14, the controller 81 estimates a self-location based on the map image data set IM13. The self-location includes the coordinates of the autonomous vehicle 10 in the map coordinate system and the attitude of the autonomous vehicle 10. The controller 81 obtains a relative positional relationship between the map image data set IM13 and the clipped image data set IM21, and calculates a relative angle between the clipped image data set IM21 and the map image data set IM13. The relative positional relationship between the map image data set IM13 and the clipped image data set IM21 is expressed by an amount of deviation between the clipped image data set IM21 and the map image data set IM13. The relative angle between the clipped image data set IM21 and the map image data set IM13 is a deviation angle between the clipped image data set IM21 and the map image data set IM13. In many cases, the clipped image data set IM21 and the map image data set IM13 do not completely agree with each other. This is because the position and the attitude of the autonomous vehicle 10 rarely completely match between the time point when the map image data set IM13 is obtained and the time point when the clipped image data set IM21 is obtained. For this reason, the clipped image data set IM21 often partially agrees with the map image data set IM13. When the position of the autonomous vehicle 10 is shifted between the time point when the map image data set IM13 is obtained and the time point when the clipped image data set IM21 is obtained, a deviation occurs between the position of the road surface Sr shown in the map image data set IM13 and the position of the road surface Sr shown in the clipped image data set IM21. The amount of this deviation represents the relative positional relationship between the map image data set IM13 and the clipped image data set IM21. The amount of deviation can be acquired from the positional relationship between the feature points of the map image data set IM13 and the feature points of the clipped image data set IM21. Similarly, due to the difference in the attitude of the autonomous vehicle 10 between the time point when the map image data set IM13 is obtained and the time point when the clipped image data set IM21 is obtained, the clipped image data set IM21 is obtained by rotating the map image data set IM13. A deviation angle generated by this rotation is a relative angle between the clipped image data set IM21 and the map image data set IM13. The controller 81 estimates the self-location based on a positional information set associated with the map image data set IM13, the relative positional relationship, and the relative angle. The controller 81 shifts the coordinate information associated with the map image data set IM13 by the amount of the coordinate corresponding to the relative positional relationship. The controller 81 shifts the orientation information associated with the map image data set IM13 by the amount corresponding to the relative angle. The controller 81 determines the coordinate point in the map coordinate system and the attitude thus obtained as the self-location.

When obtaining the relative positional relationship between the map image data set IM13 and the clipped image data set IM21, the controller 81 calculates the amount of deviation between the coordinate point associated with a positional information set in the map image data set IM13 and the coordinate point in the clipped image data set IM21 that is the same coordinate point as the coordinate point associated with the positional information set in the map image data set IM13. Then, the controller 81 uses the deviation amount as a parameter indicating the relative positional relationship between the map image data set IM13 and the clipped image data set IM21. FIG. 8 shows the relative positional relationship between the map image data set IM13 and the clipped image data set IM21. In the present embodiment, a distance L1 between the coordinate point CP1, which represents the midpoint on the chord of the map image data set IM13, and the coordinate point CP11, which represents the midpoint on the chord of the clipped image data set IM21, is a parameter indicating the relative positional relationship between the map image data set IM13 and the clipped image data set IM21. Specifically, in a case in which the map image data set IM13 and the clipped image data set IM21 are arranged such that the feature points overlap with each other, the distance L1 between the coordinate point CP1 of the map image data set IM13 and the coordinate point CP11 of the clipped image data set IM21 is a parameter indicating the relative positional relationship between the map image data set IM13 and the clipped image data set IM21. The distance L1 is a measurement in the image coordinate system. Therefore, when calculating the self-location, the controller 81 converts the relative positional relationship in the image coordinate system into the relative positional relationship in the map coordinate system. When the relative positional relationship in the image coordinate system is converted into the relative positional relationship in the map coordinate system, a pixel scale may be used. The controller 81 executing the processes of step S13 and step S14 substantially includes the self-location estimating unit 86.

Operation of the present embodiment will now be described. First, a comparative example will be described.

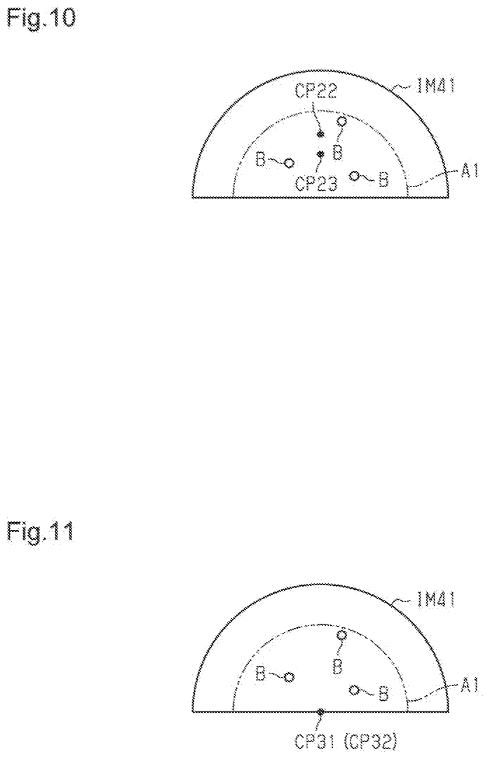

As shown in FIG. 9, a case will be discussed in which a positional information set is associated with a center pixel CP21 of a map image data set IM31. As shown in FIG. 10, the controller 81 obtains a clipped image data set IM41 and executes a matching process using the clipped image data set IM41. For illustrative purposes, it is assumed that the map image data set IM31 and the clipped image data set IM41 are captured when the autonomous vehicle 10 is at the same position and in the same attitude. Therefore, the map image data set IM31 and the clipped image data set IM41 completely agree with each other.

As described above, the relative positional relationship between the map image data set IM31 and the clipped image data set IM41 is indicated by the amount of deviation between the coordinate point associated with the positional information set in the map image data set IM31 and the coordinate point of the clipped image data set IM41 that is the same coordinate point as the coordinate point associated with the positional information set in the map image data IM31. The deviation amount between the center pixel CP21 of the map image data set IM31 and a center pixel CP22 of the clipped image data set IM41 is 0. Therefore, the controller 81 uses the positional information set associated with the center pixel CP21 of the map image data set IM31 as the self-location.

When a load is placed on the autonomous vehicle 10 or a person gets in the autonomous vehicle 10, the tires of the drive wheels 21 and the tires of the steered wheels 31 are contracted due to the weight of the load or the person. As a result, the camera 41 is lowered, reducing the distance between the camera 41 and the road surface Sr. Accordingly, the range of the road surface Sr captured by the camera 41 is reduced. As shown in FIG. 10, the clipped image data set obtained by the controller 81 in this state is a data set obtained by capturing an image of a range A1 smaller than the clipped image data set IM41 obtained in a state in which the camera 41 is not lowered. The corresponding position on the road surface Sr is different between the center pixel CP22 of the clipped image data set IM41 and the center position CP23 of the range A1. As a result, when the self-location is estimated using the clipped image data set obtained by capturing an image of the area A1, the center pixel of the clipped image data set and the center pixel CP21 of the map image data set IM31 are deviated from each other even though the image is captured in a state in which the autonomous vehicle 10 is at the same location and in the same attitude as when the clipped image data IM41 is captured. This amount of deviation causes a decrease in accuracy of the self-location estimation. For example, as shown in FIG. 9, accuracy of the self-location estimation decreases depending on the amount of deviation between the center pixel CP21 of the map image data set IM31 and the center position CP23 of the range A1.

However, in the present embodiment, a positional information set is associated with the optical axis position of the camera 41 in the image coordinate system in the map image data set. The coordinate point representing the optical axis position of the camera 41 in the image coordinate system does not change even if the camera 41 moves vertically. In other words, the optical axis position of the camera 41 in the image coordinate system corresponds to the same position on the road surface Sr even when the camera 41 moves vertically.

As shown in FIG. 11, a coordinate point CP31 representing the optical axis position of the camera 41 in the clipped image data set M41 agrees with a coordinate point CP32 representing the optical axis position of the camera 41 in the clipped image data set obtained when an image of the range A1 is captured. Therefore, the relative positional relationship between the clipped image data set IM41 and the map image data set IM31 is not changed by vertical movements of the camera 41.

The above description provides, as an example, a case in which the camera 41 is lowered due to contraction of the tires. The same applies to a case in which the vertical position of the camera 41 is different between a time point when a map image data set is obtained and a time point when a clipped image data set is obtained. For example, in a case in which a positional information set is associated with the center pixel of a map image data set, if the position of the camera 41 is higher at a time point when the clipped image data set is obtained than at a time point when the map image data set is obtained, the same problem may occur. However, by associating the positional information set with the optical axis position of the camera 41 in the image coordinate system in the map image data set, it is possible to limit a reduction in accuracy of the self-location estimation.

The present embodiment has the following advantages.

(1) The coordinate point CP1 representing the optical axis position of the camera 41 in the image coordinate system corresponds to the same position on the road surface Sr even when the position of the camera 41 moves vertically. That is, the pixel positioned at the coordinate point CP1 representing the optical axis position of the camera 41 in the image coordinate system shows a fixed position on the road surface Sr even when the camera 41 moves vertically. Therefore, even if the camera 41 moves vertically, the relative positional relationship between the map image data set and the image data set does not change. By associating a positional information set with the coordinate point CP1 representing the optical axis position of the camera 41 in the image coordinate system, it is possible to limit a decrease in accuracy of the self-location estimation due to vertical movements of the camera 41.

(2) The controller 81 executes a matching process between a clipped image data set and a map image data set. Depending on the mounting position of the camera 41, part of the vehicle body 11 may be in the image data set. At this time, by clipping a clipped image data set excluding the region where the vehicle body 11 is in, it is possible to obtain the clipped image data set excluding the region in which part of the vehicle body 11 is. If part of the vehicle body 11 is included in the clipped image data set, accuracy of the self-location estimation is lowered. By executing a matching process using the clipped image data set excluding the region in which part of the vehicle body 11 is, it is possible to limit a decrease in accuracy of the self-location estimation.

The above-described embodiment may be modified as follows. The above-described embodiment and the following modifications can be combined if the combined modifications remain technically consistent with each other.

The map image data set does not necessarily need to be a data set obtained by clipping part of an image data set. The map image data set may be a circular image data set. Even in this case, when a matching process with a clipped image data set is executed, matching may be performed by clipping part of the map image data set.

If the positional information set is associated with the coordinate point representing the optical axis position of the camera 41 in the image coordinate system, the positional information set does not necessarily need to be included in the map image data set. That is, the coordinate point representing the optical axis position of the camera 41 in the image coordinate system may be outside the range of the map image data set.

The storage device that stores the map data set M1 may be the storage unit 83.

The coordinate system representing the pixel position of the map image data set and the coordinate system representing the pixel position of the image data set may be different coordinate systems.

The controller 81 does not necessarily need to include the map generating unit 84. That is, the controller 81 does not necessarily need to have the function of generating the map data set M1. For example, when there are multiple autonomous vehicles 10, the map data set M1 may be generated by one of the autonomous vehicles 10, and this map data set M1 may be copied and used by the remaining autonomous vehicles 10.

The camera 41 may be provided at a position different from the bottom of the vehicle body 11 if the camera 41 is arranged to face the vertical direction.

The map generating unit 84, the obtaining unit 85, and the self-location estimating unit 86 may be separate devices.

1. An autonomous vehicle, comprising:
a camera that is arranged to face in a vertical direction so as to capture images of a road surface;
a storage device that is configured to store a map data set that associates a positional information set with each of multiple map image data sets obtained by capturing images of the road surface in advance; and
circuitry that is configured to obtain an image data set from the camera and estimate a self-location using the map data set and the image data set, wherein
the circuitry is configured to
obtain a clipped image data set by clipping a predetermined range from the image data set,
identify one of the map image data sets that corresponds to the clipped image data set by executing a matching process between the clipped image data set and at least one of the map image data sets, and
estimate the self-location from a relative positional relationship between the identified map image data set and the clipped image data set, and
each positional information set is associated with a coordinate point representing an optical axis position of the camera in a coordinate system representing a pixel position of the corresponding map image data set.

2. A self-location estimating method in an autonomous vehicle, the method comprising:
capturing images of a road surface with a camera that is arranged in the autonomous vehicle so as to face in a vertical direction;
storing, in a storage device, a map data set that associates a positional information set with each of multiple map image data sets obtained by capturing images of the road surface in advance;
obtaining an image data set from the camera;
obtaining a clipped image data set by clipping a predetermined range from the image data set;
identifying one of the map image data sets that corresponds to the clipped image data set by executing a matching process between the clipped image data set and at least one of the map image data sets; and
estimating the self-location from a relative positional relationship between the identified map image data set and the clipped image data set,
wherein each positional information set is associated with a coordinate point representing an optical axis position of the camera in a coordinate system representing a pixel position of the corresponding map image data set.
